(19) United States
(12) Patent Application Publication
(10) Pub. No.: US 2023/0245241 A1
(43) Pub. Date: Aug. 3, 2023

(54) CLAIM ROUTING BASED ON LIABILITY CLASSIFICATION

(71) Applicant: State Farm Mutual Automobile Insurance Company, Bloomington, IL (US)

(72) Inventors: Thaddeus Robert Sulek, Alpharetta, GA (US); Ruth Anne Grosskopf, Bloomington, IL (US); Justin Devore, Atlanta, IL (US); Dayne Dalpoas, Delavan, IL (US); Sateesh K Nallamothu, Normal, IL (US); Scott Page Keller, Peoria, AZ (US); Jason Beckman, Bloomington, IL (US)

(21) Appl. No.: 17/735,995

(22) Filed: May 3, 2022

Related U.S. Application Data
(60) Provisional application No. 63/304,461, filed on Jan. 28, 2022.

(51) Int. Cl. G06Q 40/08

(52) U.S. Cl. CPC G06Q 40/08

(57) ABSTRACT

Insurance claims can be assigned to different claim processing groups within an insurance company. A machine learning liability classifier can evaluate claim data for an insurance claim, to predict a likelihood that an insured party has either 0% or 100% liability. If the likelihood of the insured party having either 0% or 100% liability meets or exceeds a threshold, the insurance claim can be assigned directly to a non-complex claim processing group that processes relatively simple insurance claims. Otherwise, one or more downstream claim routing elements can further process the claim data to determine whether the insurance claim is to be assigned to the non-complex claim processing group or to a complex claim processing group that processes more complex insurance claims.

### RELATED APPLICATIONS

This U.S. patent application claims priority to provisional U.S. Patent Application No. 63/304,461, entitled “CLAIM ROUTING BASED ON LIABILITY CLASSIFICATION,” filed on Jan. 28, 2022, the entirety of which is incorporated herein by reference.

### TECHNICAL FIELD

The present disclosure relates to routing insurance claims for processing, and more particularly to routing insurance claims based at least in part on predictions, generated by a machine learning liability classifier, indicating likelihoods that insured parties have either 0% liability or 100% liability.

### BACKGROUND

An insurance company can have numerous claim handlers, representatives, associates, or other individuals who can perform one or more tasks to process an insurance claim. For example, a claim handler can at least partially process an insurance claim by determining insurance policy coverage, determining liability, determining damage amounts, and/or performing other actions that may be involved in handling or processing the insurance claim overall.

The insurance company may group claim handlers, and/or other workers who can at least partially process insurance claims, into different claim processing groups, such as different groups, segments, or tiers. Different groups, segments, or tiers may, in some examples, correspond to different claim complexity levels, different claim types, and/or other differing claim attributes. For example, the insurance company may have a non-complex claim processing group that primarily processes relatively simple insurance claims, and a complex claim processing group that primarily processes more complex insurance claims. However, when an insurance claim is initially submitted to the insurance company, it may be unclear how complex the insurance claim is, what issues may be involved in processing the insurance claim, and/or to which claim processing group the insurance claim should be assigned.

Some insurance companies use static rules to determine which claim processing group should be assigned to process a new insurance claim. However, in some cases, insurance claims that are initially assigned to one claim processing group according to such static rules may later be reassigned or transferred to a different claim processing group. For instance, static rules may indicate that a particular insurance claim should be assigned to a complex claim processing group, and the insurance claim can thus be assigned to the complex claim processing group. However, at a later point in time, a worker in the complex claim processing group may determine that the insurance claim is actually relatively simple, and the worker may request that the insurance claim be transferred or reassigned to the non-complex claim processing group.

Similarly, an insurance company may use a comparative negligence model to estimate a likelihood that processing an insurance claim will involve determining comparative negligence levels associated with multiple parties. If the comparative negligence model indicates a relatively high likelihood of an insurance claim involving comparative negligence issues, such as a likelihood that exceeds a threshold value, the insurance claim can be assigned to the complex claim processing group. However, in some examples, the complex claim processing group may ultimately determine that an insured party associated with the insurance claim had 0% liability or had 100% liability, even if the comparative negligence model had indicated a relatively high likelihood of the insurance claim involving comparative negligence issues. Accordingly, the insurance claim may actually have been relatively simple due to the 0% liability or 100% liability of the insured party, and could have been handled by the non-complex claim processing group. In these situations, a worker in the complex claim processing group may request that the insurance claim be transferred to the non-complex claim processing group for further processing.

Transfers or reassignments of insurance claims between claim processing groups may introduce delays in claim processing, as in some cases claim processing does not begin, or is not completed, until an insurance claim is reassigned from an initially-assigned claim processing group to a different claim processing group. An initial assignment of an insurance claim to a claim processing group that does not ultimately process the insurance claim can also lead to an inefficient use of resources. For example, computing resources, worker time, and/or other resources associated with an initially-assigned claim processing group may be wasted if an insurance claim is ultimately transferred to a different claim processing group that actually processes the insurance claim. Initially assigning insurance claims to claim processing groups that later transfer the insurance claims to other claim processing groups can also lead to increased network traffic and increased bandwidth usage as data associated with insurance claims is transferred between computing devices associated with the claim processing groups.

The example systems and methods described herein may be directed toward mitigating or overcoming one or more of the deficiencies described above.

### SUMMARY

The systems and methods described herein can assign an insurance claim to a claim processing group within an insurance company, based at least in part on evaluating claim data with a machine learning liability classifier configured to predict a likelihood that an insured party has either 0% or 100% liability for a loss. If the liability classifier determines that the likelihood of the insured party having either 0% or 100% liability meets or exceeds a threshold, the insurance claim is likely relatively simple and can be assigned to a non-complex claim processing group that is set up to process relatively simple insurance claims. However, if the liability classifier determines that the likelihood of the insured party having either 0% or 100% liability is below the threshold, the insurance claim may be more complicated, and one or more downstream claim routing elements can further evaluate the insurance claim to determine whether the insurance claim should be assigned to the non-complex claim processing group or to a complex claim processing group that is set up to process more complex insurance claims. By using the liability classifier to identify insurance claims in which the insured party is likely to have either 0% or 100% liability, such insurance claims can be assigned to the non-complex claim processing group more quickly, and the system can avoid having other downstream claim routing elements further evaluate the insurance claims to determine which claim processing group should be assigned to process the insurance claims.

According to a first aspect, a computer-implemented method can include obtaining, by one or more processors, claim data associated with an insurance claim. The computer-implemented method can also include generating, by the one or more processors, and using a liability classifier based on the claim data, a prediction of a likelihood of an insured party associated with the insurance claim having either 0% liability or 100% liability for a loss. The computer-implemented method can additionally include determining, by the one or more processors, that the likelihood meets or exceeds a threshold. The computer-implemented method can further include generating, by the one or more processors, and based on the likelihood meeting or exceeding the threshold, a claim routing decision indicating that the insurance claim is to be assigned to a non-complex claim processing group configured to process less complex insurance claims than a complex claim processing group. The computer-implemented method can also include causing, by the one or more processors, the claim data to be routed to one or more computing devices associated with the non-complex claim processing group.

According to a second aspect, a system can comprise a claim intake system, a liability classifier, and a claim router. The claim intake system can be configured to obtain claim data associated with an insurance claim. The liability classifier can be configured to generate, based on the claim data, a prediction of a likelihood of an insured party associated with the insurance claim having either 0% liability or 100% liability for a loss. The claim router can be configured to compare the likelihood to a threshold. The claim router can also be configured to route the claim data to a non-complex claim processing group based on the likelihood being equal to or above the threshold. The claim router can further be configured to route the claim data to a downstream claim routing element, configured to further process the claim data to determine whether to route the claim data to the non-complex claim processing group or to a complex claim processing group, based on the likelihood being below the threshold.

According to a third aspect, one or more non-transitory computer-readable media can store computer-executable instructions that, when executed by one or more processors, cause the one or more processors to perform operations. The operations can include receiving claim data associated with an insurance claim. The operations can also include generating, using a liability classifier based on the claim data, a prediction of a likelihood of an insured party associated with the insurance claim having either 0% liability or 100% liability for a loss. The operations can further include determining that the likelihood meets or exceeds a threshold. The operations can additionally include generating, based on the likelihood meeting or exceeding the threshold, a claim routing decision indicating that the insurance claim is to be assigned to a non-complex claim processing group configured to process less complex insurance claims than a complex claim processing group. The operations can also include causing the claim data to be routed to one or more computing devices associated with the non-complex claim processing group.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows a first example of a system configured to assign insurance claims to claim processing groups associated with an insurance company.

FIG. 2 shows a second example of a system configured to assign insurance claims to claim processing groups associated with an insurance company.

FIG. 3 shows an example of a liability classifier using a set of factors to evaluate claim data associated with an insurance claim submitted to an insurance company.

FIG. 4 shows a flowchart illustrating an example method for determining whether to assign an insurance claim to either a non-complex claim processing group or a complex claim processing group.

FIG. 5 shows an example system architecture for a computing device associated with the systems described herein.

### DETAILED DESCRIPTION

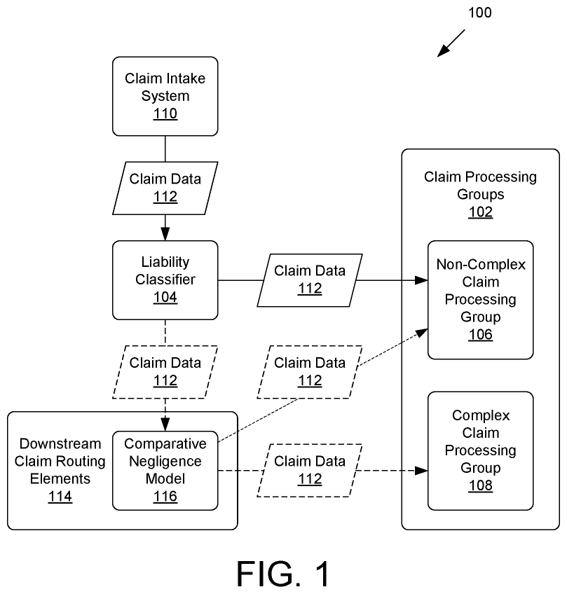

FIG. 1 shows a first example of a system 100 configured to assign insurance claims to claim processing groups 102 associated with an insurance company. An insurance claim can be an automobile insurance claim, a fire insurance claim, a flood insurance claim, a life insurance claim, a home insurance claim, or any other type of insurance claim submitted to the insurance company. The insurance company may have multiple claim processing groups 102 that process insurance claims. The system 100 described herein can assign insurance claims to claim processing groups 102 selected for individual insurance claims based at least in part on predictions generated by a liability classifier 104 in association with the individual insurance claims, as described further below.

The claim processing groups 102 can include claim handlers, claims adjustors, specialists, and/or other types of workers who perform tasks to process insurance claims. As a non-limiting example, an individual in a group can process an automobile insurance claim by performing tasks to determine whether parties have insurance coverage, determine how much insurance coverage the parties have, determine which party is at fault, determine if multiple parties are at fault in a comparative negligence situation, determine amounts to be paid to one or more parties, negotiate with insurers of other insured parties during subrogation situations, and/or take other actions to at least partially process and/or resolve the automobile insurance claim.

The claim processing groups 102 can include a non-complex claim processing group 106 and a complex claim processing group 108. The non-complex claim processing group 106 can specialize in processing relatively simple insurance claims, while the complex claim processing group 108 can specialize in processing more complex insurance claims. For example, the complex claim processing group 108 can specialize, or have more experience than the non-complex claim processing group 106, in processing insurance claims that involve comparative negligence issues. As a non-limiting example, the complex claim processing group 108 may process an insurance claim in part by determinizing that a first party was 70% at fault for a loss, and that a second party was 30% at fault for the loss, such that both parties have some liability for the loss in a comparative negligence situation. The non-complex claim processing group 106 may be set up to process simpler types of insurance claims, such as insurance claims that involve a single party, or insurance claims associated with losses in which a single party is fully at fault.

The system 100 can include a claim intake system 110 that can collect, generate, and/or output claim data 112 associated with an insurance claim. In some examples, the claim intake system 110 can be part of the system 100. In other examples, the claim intake system 110 can be separate from the system 100, but one or more elements of the system 100 can receive claim data 112 from the separate claim intake system 110.

The claim intake system 110 can collect or generate the claim data 112 associated with the insurance claim based on data about a loss, such as information about an accident or other incident. The claim data 112 may be submitted directly, or indirectly, to the claim intake system 110 by customers of an insurance company, third-party claimants, insurance agents, call center representatives, claim handlers, and/or other individuals or entities. In some examples, the claim intake system 110 can be a computer-executable application, a web-based portal, a mobile application, or other system with a user interface that can receive user input associated with a loss. The claim data 112 can include data input by users, data inferred or derived from data input by users, and/or other types of data associated with the claim. In some examples, the claim data 112 can be, or include, a first notice of loss (FNOL), or other type of loss report associated with the insurance claim.

As a non-limiting example, when an individual wants to report a loss and/or file the insurance claim with the insurance company, the individual can call or otherwise contact a representative of the insurance company, such as an agent, a call center representative, a claim handler, or other representative. The individual may provide information about the loss to the representative, for instance by describing details about an accident and/or by responding to questions posed by the representative. The representative can in turn input data into the claim intake system 110 based on the information provided by the individual. For example, the claim intake system 110 may have a user interface that the representative can use to enter information about a loss that the representative has received from a caller, enter information about the loss that the representative has inferred from information provided by the caller, and/or enter any other information about the loss. The claim intake system 110 may collect and/or generate the claim data 112 associated with the insurance claim based on such user input.

As another non-limiting example, the claim intake system 110 may have, or be associated with, a website, mobile application, or other system that an individual can use to directly report a loss and/or file the insurance claim. For example, a customer of the insurance company may use a website or mobile application to directly file the insurance claim and provide corresponding information without communicating with a representative, and/or to upload pictures or other information associated with the insurance claim. The claim intake system 110 may collect and/or generate the claim data 112 associated with the insurance claim based on such user input.

In some examples, the claim intake system 110 can also collect or generate the claim data 112 associated with the insurance claim based on data provided by other entities. For example, the insurance claim can be an automobile insurance claim, and the claim data 112 can include, or be based on, a damage estimate provided by an automotive body shop.

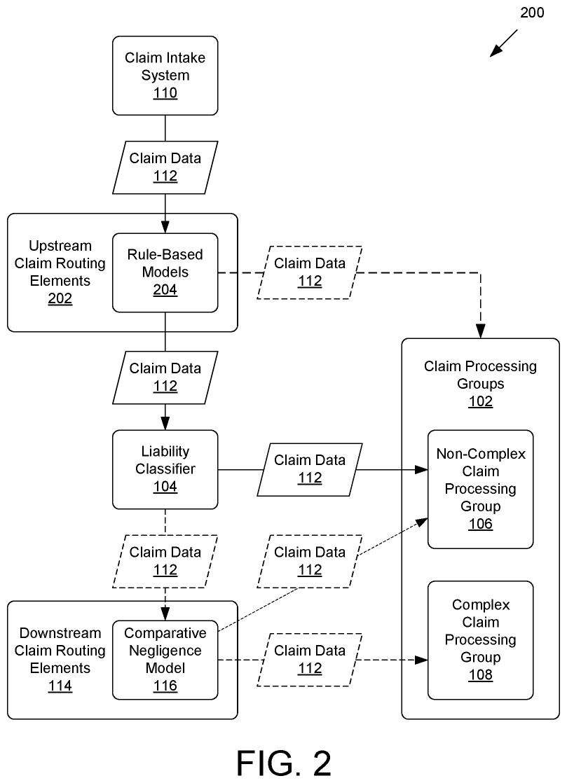

The claim intake system 110 can provide the claim data 112, such as an FNOL or other loss report, and/or other information associated with the insurance claim to one or more other elements of the system 100. For example, the liability classifier 104 can receive the claim data 112. In some examples, for instance as discussed further below with respect to FIG. 2, one or more filters, rule-based models, or other models or processing elements may operate on and/or evaluate the claim data 112 before the claim data 112 is provided to the liability classifier 104. However, in other examples, the liability classifier 104 can receive the claim data 112 directly from the claim intake system 110, or from a database or other repository that at least temporarily stores the claim data 112 output by the claim intake system 110.

The liability classifier 104 can be a machine learning model configured to predict, based on the claim data 112, a likelihood that a party insured by the insurance company has either 0% liability for the loss associated with the insurance claim or has 100% liability for the loss. As a non-limiting example, the liability classifier 104 may predict that there is a 95% chance that the insured party has either 0% or 100% liability, and a 5% chance that the insured party has somewhere between 0% and 100% liability. In some examples, if multiple parties associated with the insurance claim are insured by the insurance company, the liability classifier 104 may be configured to predict a likelihood that either any of the insured parties have 100% liability or that all of the insured parties have 0% liability. As described herein, an insured party having either 0% liability or 100% liability can indicate a clear fault level associated with a loss, while the insured party having between 0% liability and 100% liability may indicate a shared fault level associated with the loss. Although 0% liability and 100% liability are used as examples of clear fault levels herein, in other examples a clear fault level can be expressed using different thresholds, or via different types of representations other than percentages. For instance, the liability classifier 104 can be configured to predict, based on the claim data 112, a likelihood that an insured party is associated with a clear fault level, where the clear fault level is defined as either 0% liability or 100% liability, or is defined using other thresholds or another expression of a clear fault level.

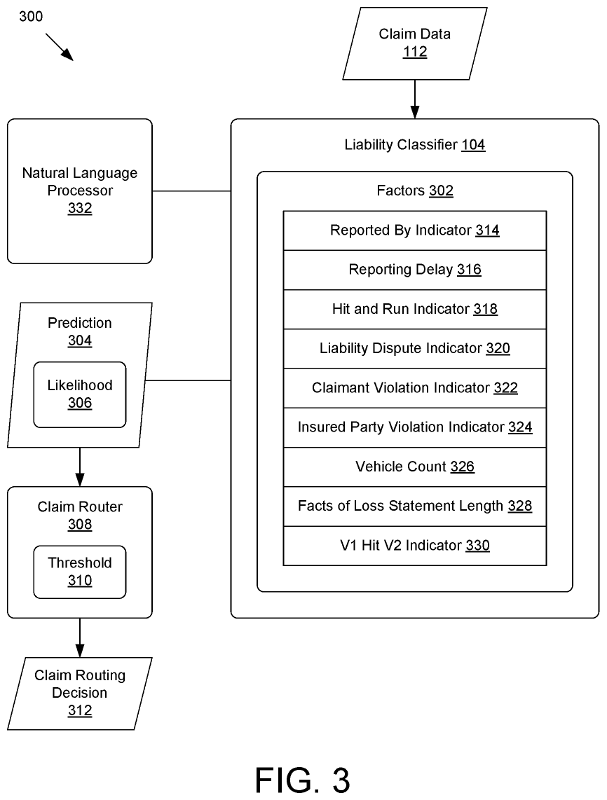

The liability classifier 104 can be based on Gradient Boosted Machines (GBMs), Random Forest algorithms, regression analysis, convolutional neural networks, recurrent neural networks, other types of neural networks, nearest-neighbor algorithms, deep learning algorithms, and/or other types of artificial intelligence or machine learning frameworks. For instance, in some examples, the liability classifier 104 can be based on the open-source “CatBoost” algorithm for gradient boosting on decision trees. The “CatBoost” algorithm can be configured to evaluate categorical features that may be associated with numeric and/or non-numeric input values associated with the claim data 112, for example without using Weight of Evidence (WoE) coding or other operations to convert non-numeric values into numeric values. The “CatBoost” algorithm can use modeling trees with hyperparameters that produce similar quality output with or without parameter tuning. In other examples, the liability classifier 104 can be based on other types of machine learning frameworks, such as a Logistic Regression model that can evaluate numeric input values associated with the claim data 112. In some examples in which the liability classifier 104 is based on a Logistic Regression model, the system 100 can be configured to use WoE coding and/or other operations convert any character variables or other non-numeric values associated with the claim data 112 into numeric values that can be processed by the Logistic Regression model. Example types of data associated with the claim data 112 that can be used by the liability classifier 104 to generate a corresponding prediction of whether an insured party is likely to have either 0% or 100% liability are discussed further below with respect to FIG. 3.

As shown in FIG. 1, if the liability classifier 104 predicts, based on the claim data 112, that the likelihood of an insured party having either 0% or 100% liability exceeds a threshold value, the system 100 can cause the claim data 112 to be routed to the non-complex claim processing group 106. The threshold value can be set to 80%, 90%, 95%, or any other threshold value. For example, if the threshold value is set to 90% and the liability classifier 104 predicts, based on the claim data 112, that there is a 95% chance that the insured party has either 0% or 100% liability for the loss, it may be highly likely that the insurance claim is relatively simple and can be processed by the non-complex claim processing group 106. Accordingly, the system 100 can assign the insurance claim directly to the non-complex claim processing group 106 for further processing, for instance by routing the claim data 112 to a computing device or database associated with the non-complex claim processing group 106.

In a situation in which the system 100 assigns the insurance claim directly to the non-complex claim processing group 106 based on evaluation of the claim data 112 by the liability classifier 104, one or more downstream claim routing elements 114 of the system 100 can avoid processing the claim data 112. The downstream claim routing elements 114 can be other elements of the system 100, positioned downstream of the liability classifier 104, that are configured to process the claim data 112 to determine whether to assign the insurance claim to the non-complex claim processing group 106 or to the complex claim processing group 108. For instance, in some examples the downstream claim routing elements 114 can include a comparative negligence model 116 that is configured to evaluate the claim data 112 to determine a likelihood that comparative negligence is associated with the insurance claim. The comparative negligence model 116 can be a rule-based model, a separate machine learning model, or any other type of model.

In some examples, the system 100 can use output of one or more of the downstream claim routing elements 114 (such as the comparative negligence model 116), generated based on the claim data 112, to determine whether to assign the insurance claim to the non-complex claim processing group 106 or the complex claim processing group 108. As a non-limiting example, the system 100 can be configured with an 85% comparative negligence likelihood threshold. In this example, if output of the comparative negligence model 116 indicates that the insurance claim is at least 85% likely to involve comparative negligence issues, the system 100 can assign the insurance claim to the complex claim processing group 108. However, if output of the comparative negligence model 116 indicates that the insurance claim is less than 85% likely to involve comparative negligence issues, the system 100 can assign the insurance claim to the non-complex claim processing group 106 and/or cause other downstream claim routing elements 114 to evaluate the claim data 112. In other examples, the comparative negligence likelihood threshold can be set to another value that is higher or lower than 85%, or the system 100 can use the output of the comparative negligence model 116 in other ways to determine whether to assign the insurance claim to the non-complex claim processing group 106 or the complex claim processing group 108.

Although the comparative negligence model 116 may indicate that some insurance claims have likelihoods of involving comparative negligence issues that are equal to or higher than the comparative negligence likelihood threshold, in practice some of those insurance claims may be relatively simple insurance claims that could be processed by the non-complex claim processing group 106. As a non-limiting example, although the comparative negligence model 116 may determine that it is 88% likely that an insurance claim will involve comparative negligence issues, there can still be a chance even in a multi-party situation that an insured party is either 0% liable or 100% liable. As shown in FIG. 1, the liability classifier 104 can be positioned upstream of the comparative negligence model 116 and/or other downstream claim routing elements 114 to identify insurance claims for which insured parties are likely to be 0% liable or 100% liable, and divert those identified claims to the non-complex claim processing group 106 to prevent the corresponding claim data from reaching and being processed by the comparative negligence model 116 and/or other downstream claim routing elements 114.

Accordingly, a first set of insurance claims with insured parties that the liability classifier 104 indicates are likely to have either 0% liability or 100% liability can be routed directly to the non-complex claim processing group 106. A second set of insurance claims, with insured parties that the liability classifier 104 indicates are likely to have between 0% liability and 100% liability, can be provided to the downstream comparative negligence model 116 and/or other downstream claim routing elements 114 for further claim routing evaluation. The second set of insurance claims, with insured parties that the liability classifier 104 indicates are likely to have somewhere between 0% liability and 100% liability, may be more likely than the first set of insurance claims to involve comparative negligence issues, and can thus be better candidates to be evaluated by the comparative negligence model 116 than the first set of insurance claims. The comparative negligence model 116 can evaluate claim data 112 associated with the second set of insurance claims to determine likelihoods that the insurance claims involve comparative negligence, and the system 100 can provide corresponding claim data 112 to either the non-complex claim processing group 106 or the complex claim processing group 108, or to other downstream claim routing elements 114, based on the comparative negligence likelihoods determined by the comparative negligence model 116.

Overall, the liability classifier 104 can identify insurance claims in which parties insured by the insurance company have at least a threshold likelihood of having either 0% liability or 100% liability. Because an insured party associated with such an insurance claim is likely either fully at fault for a loss, or has no fault for the loss, the insurance claim can be unlikely to involve any comparative negligence issues and/or may be relatively simple to process. Accordingly, the system 100 can assign the insurance claim to the non-complex claim processing group 106 directly, without using the comparative negligence model 116 to further evaluate the insurance claim for comparative negligence issues that may be unlikely to be associated with the insurance claim, and/or without using other downstream claim routing elements 114 to further process the claim data 112 to determine which of the claim processing groups 102 should handle the insurance claim.

The liability classifier 104 can thus increase the likelihood that insurance claims that for which insured parties are likely to have either 0% liability or 100% liability are assigned initially to the non-complex claim processing group 106. By increasing the likelihood of such insurance claims being assigned initially to the non-complex claim processing group 106, the chances of such claims being initially assigned to the complex claim processing group 108 and then being transferred or reassigned to the non-complex claim processing group 106 can be similarly reduced. The system 100 can thereby cause insurance claims to be processed more quickly and/or more efficiently by the claim processing groups 102. This can reduce cycle times to settlements associated with insurance claims, increase quality of investigations by the claim processing groups 102, and decrease overall lifecycles of insurance claims.

In addition, the presence of the liability classifier 104 in the system 100 can result in lower overall usage of computing resources and network bandwidth. For example, if an insurance claim were assigned to the complex claim processing group 108 initially, but later was transferred to the non-complex claim processing group 106 after a determination that an insured party had 0% liability or 100% liability, there may be network messages associated with the transfer of the insurance claim sent between computing devices associated with the complex claim processing group 108 and the non-complex claim processing group 106. However, because the liability classifier 104 can identify insurance claims with insured parties that are likely to have 0% liability or 100% liability, and the system 100 can route such insurance claims directly to the non-complex claim processing group 106, the liability classifier 104 can prevent such insurance claims from being initially assigned to the complex claim processing group 108. Accordingly, network messages associated with the transfer of such insurance claims from the complex claim processing group 108 to the non-complex claim processing group 106 can be avoided, and usage of network bandwidth can be reduced overall. As another example, usage of processing cycles, memory, and/or other computing resources of computing devices associated with the complex claim processing group 108 can be avoided by initially assigning such insurance claims to the non-complex claim processing group 106 based on predictions made by the liability classifier 104, instead of initially assigning such insurance claims to the complex claim processing group 108 and later re-assigning the insurance claims to the non-complex claim processing group 106.

Similarly, because the liability classifier 104 can identify insurance claims with insured parties that are likely to have 0% liability or 100% liability, and the system 100 can route such insurance claims directly to the non-complex claim processing group 106 instead of having the downstream comparative negligence model 116 and/or other downstream claim routing elements 114 further evaluate the insurance claims, usage of processing cycles, memory, and/or other computing resources of computing devices associated with the comparative negligence model 116 and/or other downstream claim routing elements 114 can be reduced. For instance, while the system 100 may otherwise cause the comparative negligence model 116 to evaluate claim data 112 associated with all received insurance claims, or a relatively large percentage of insurance claims, insurance claims that are likely to have insured parties with 0% liability or 100% liability can be identified by the upstream liability classifier 104 and assigned directly to the non-complex claim processing group 106. Accordingly, the system 100 can avoid having the comparative negligence model 116 to evaluate the claim data 112 for such insurance claims that are unlikely to involve comparative negligence issues, and the number of insurance claims that the comparative negligence model 116 evaluates can be reduced overall. By reducing the number of insurance claims that the comparative negligence model 116 evaluates, the comparative negligence model 116 can use fewer computing resources over a period of time, and/or can be more efficient at evaluating insurance claims that may be more likely to involve comparative negligence issues.

As discussed above, the liability classifier 104 can be positioned upstream of the comparative negligence model 116 and/or other downstream claim routing elements 114 in the system 100. However, in some examples, one or more other elements can be positioned upstream of the liability classifier 104 to filter and/or evaluate claim data 112 before the claim data 112 reaches the liability classifier 104.

For instance, FIG. 2 shows a second example of a system 200 configured to assign insurance claims to claim processing groups 102 associated with an insurance company. The system 200 can be similar to the system 100 shown in FIG. 1, but can have one or more upstream elements 202, such as rule-based models 204 and/or other claim routing elements, positioned upstream of the liability classifier 104. For example, in system 200, claim data 112 from the claim intake system 110 can initially be provided to the one or more rule-based models 204. The rule-based models 204 may be based on sets of pre-set static rules configured to identify insurance claims that should be assigned to specific claim processing groups 102.

For example, the rule-based models 204 may have a static rule indicating that if claim data 112 for an insurance claim shows that only one vehicle was involved in a corresponding accident, the insurance claim should be assigned directly to the non-complex claim processing group 106. Accordingly, in this example, the static rule of the rule-based models 204 can identify insurance claims associated with a single vehicle and cause the system 200 to assign those insurance claims to the non-complex claim processing group 106, such that the liability classifier 104 and the downstream claim routing elements 114 of the system 200 can avoid evaluating the corresponding claim data 112.

The rule-based models 204 can accordingly identify any insurance claims that static rules indicate should be assigned directly to the non-complex claim processing group 106 or the complex claim processing group 108. Accordingly, the system 200 can assign insurance claims that satisfy rules of the rule-based models 204 to corresponding claim processing groups 102. Any other insurance claims that do not satisfy any rules of the rule-based models 204, or are not otherwise flagged by other upstream elements 202 to be processed by specific claim processing groups 102, can be provided to the liability classifier 104 and/or the downstream claim routing elements 114 of the system 200 for further evaluation to determine where the insurance claims should be routed to, as discussed above with respect to FIG. 1.

Static rules implemented by the rule-based models 204 may be based on regulatory requirements, business logic, and/or other rationales indicating that certain types of claims should be processed by certain claim processing groups 102. However, while individual rules of the rule-based models 204 may be hard coded to evaluate one, two, or other relatively small numbers of values or data types that may be present in claim data 112, machine learning models such as the liability classifier 104 can be configured to dynamically evaluate multiple values or data types, and/or different combinations of values or data types, that may be present in claim data 112. For example, an example set of factors associated with claim data 112 that the liability classifier 104 can be trained to consider and/or weight is discussed further below with respect to FIG. 3. Accordingly, while rule-based models 204 may filter claim data 112 for some insurance claims from reaching the liability classifier 104 and/or the downstream claim routing elements of system 200, the liability classifier 104 can operate on any claim data 112 that is not filtered by the rule-based models 204.

FIG. 3 shows an example of the liability classifier 104 using a set of factors 302 to evaluate claim data 112 associated with an insurance claim submitted to an insurance company. The set of factors 302 can indicate types of data that may be present in the claim data 112, or that the liability classifier 104 can derive from the claim data 112. Individual factors 302 can be associated with weights or other values that indicate how likely a particular factor is to be predictive of an insured party being either 0% liable or 100% liable for a loss. The liability classifier 104 can identify values for individual factors 302 based on the claim data 112, and can use the values and corresponding weights for the factors 302 to generate a prediction 304. The prediction 304 can indicate a likelihood 306 of a party insured by the insurance company being either 0% liable or 100% liable for a loss associated with the insurance claim. The liability classifier 104 can have, or be associated with, a claim router 308 configured to evaluate the prediction 304 based on a threshold 310. For example, the claim router 308 can compare the likelihood 306 of the insured party being either 0% liable or 100% liable, as indicated by the prediction 304, against a threshold 310 of 80%, 90%, 95%, or any other value. In some examples, the value of the threshold 310 can be adjustable by an owner or operator of a system that includes the liability classifier 104. The claim router 308 can generate a claim routing decision 312 based on the comparison of the likelihood 306 and the threshold 310. The claim routing decision 312 can indicate whether the insurance claim, corresponding to the claim data 112, is to be assigned to the non-complex claim processing group 106, or whether the claim data 112 should be provided for further processing to the comparative negligence model 116 and/or other downstream claim routing elements 114 of a system such as system 100 or system 200.

For example, if the likelihood 306 of the insured party being either 0% liable or 100% liable meets or exceeds the threshold 310, the claim routing decision 312 can indicate that the claim data 112, and/or associated insurance claim, is to be routed to the non-complex claim processing group 106. However, if the likelihood 306 of the insured party being either 0% liable or 100% liable is less than the threshold 310, the claim routing decision 312 can indicate that the claim data 112 is to be routed on to the comparative negligence model 116 and/or other downstream claim routing elements 114.

The individual factors 302, and/or corresponding weights for the individual factors 302, used in the liability classifier 104 can be determined by training the machine learning model associated with the liability classifier 104. As discussed above, the liability classifier 104 can be based on a “CatBoost” model, a Logistic Regression model, or another type of machine learning model.

In some examples, the machine learning model associated with the liability classifier 104 can be trained using a supervised machine learning approach, based on training set of data that includes numerous data points associated with insurance claims, claim processing groups 102, previous assignments of the insurance claims to the claim processing groups 102, claim processing decisions made by the claim processing groups 102 indicating whether insured parties associated with the insurance claims had 0% or 100% liability, and/or other types of data points. Some of the data points can be “features” for machine learning algorithms, while indications of whether insured parties associated with insurance claims were determined to have 0% or 100% liability can be “labels” for the machine learning algorithms. Supervised learning algorithms can determine weights for different features, and/or for different combinations of features, from the training set that optimize prediction of the labeled indications in the training set of which insurance claims were determined to have insured parties with 0% or 100% liability. For instance, machine learning algorithms can determine which combinations of features in the training set are statistically more relevant to predicting which insurance claims were determined to have insured parties with 0% or 100% liability, and/or determine weights for different features, and can thus prioritize those features in relative relation to each other. After the machine learning model of the liability classifier 104 has been trained, the trained machine learning model of the liability classifier 104 can be used to infer probabilistic outcomes when the trained machine learning model is presented with new data of the type on which it was trained, such as claim data 112 for new insurance claims received by the insurance company.

In some examples, the liability classifier 104 can be trained using supervised machine learning according to a training set of data, until the liability classifier 104 can accurately make predictions that match a validation set of data to at least a threshold degree of accuracy. After the liability classifier 104 has been trained, the liability classifier 104 can also, or alternately, be tested to confirm that it can make predictions that match, to a threshold degree of accuracy, a test set of data that was not included in the training set or validation set. As a non-limiting example, the liability classifier 104 can be tested, validated, and/or tested on a set of eight months of historical data about insurance claims in which insured parties were determined to have either 0% or 100% liability, and the liability classifier 104 can be further validated and/or tested on an out-of-time set of three months of historical data collected after the initial set of eight months of historical data.

The factors 302 shown in FIG. 3 can be examples of features that the training of the machine learning model indicates should be evaluated and/or weighted by the liability classifier during generation of the prediction 304 based on the claim data 112. The factors 302 shown in FIG. 3 include a “reported by” indicator 314, a reporting delay 316, a hit and run indicator 318, a liability dispute indicator 320, a claimant violation indicator 322, an insured party violation indictor 324, a vehicle count 326, a facts of loss statement length 328, and a “V1 hit V2” indicator 330. However, the factors 302 shown in FIG. 3 are a non-limiting example, and the liability classifier 104 can consider more, fewer, and/or different factors 302 than are shown in FIG. 3.

In some examples, training and/or generation of the liability classifier 104 can be initiated with a relatively large group of features that may be considered, and the training of the liability classifier 104 can indicate which of the features are the most predictive of whether an insured party has either 0% or 100% liability, and that should thus be used as factors 302 in the liability classifier 104. For example, the training of the liability classifier 104 can involve a feature selection phase in which the set of factors 302 are narrowed over time based on cluster analysis, Random Forest algorithms, stepwise procedures, and/or other operations, for instance to remove features from consideration that are similar to, and/or highly correlated with, other features. Accordingly, over time, training of the liability classifier 104 can narrow in on a set of predictive features, such as the non-limiting example set of factors 302 shown in FIG. 3 that includes the “reported by” indicator 314, the reporting delay 316, the hit and run indicator 318, the liability dispute indicator 320, the claimant violation indicator 322, the insured party violation indictor 324, the vehicle count 326, the facts of loss statement length 328, and the “V1 hit V2” indicator 330.

The “reported by” indicator 314 can be a code, value, or other element of the claim data 112 that identify a party that reported the insurance claim to the insurance company. For example, the “reported by” indicator 314 may indicate whether the insurance claim was reported by the claimant, the claimant's attorney, a contractor, an insurance carrier, an insured party associated with the insurance company, the insured party's attorney, a relative of the insured party, a medical provider, a mortgagee, a public adjuster, an insurance agent, or another party. In some examples, one of more specific types of parties identified in the “reported by” indicator 314 can be more predictive of whether the insured party is 0% or 100% liable than other types of parties. For instance, in some examples it may be more likely that the insured party is 0% or 100% liable if the “reported by” indicator 314 identifies the claimant or the insured party, than if the reported by” indicator 314 identifies other types of parties.

The reporting delay 316 can be a value indicating a time period, such as a number of days, between a date when the loss associated with the insurance claim occurred and the data when the claim data 112 was reported to, and/or received by, the insurance company. In some examples, the liability classifier 104 or an associated system element can calculate or derive the reporting delay 316 based on a difference between a date of the loss indicated in the claim data 112 and a date the claim data 112 was created or received. In various examples, the amount of days between a loss and when the claim data 112 is reported may be indicative of a likelihood that the insured party is 0% or 100% liable. For example, training data may indicate that a shorter reporting delay 316 is more likely to indicate that an insured party is 0% or 100% liable than a longer reporting delay 316.

The hit and run indicator 318 can be a binary value, input into the claim data 112 by a representative or other user, indicating whether or not the loss associated with the insurance claim was reported to be associated with a hit and run incident. In some examples, it may be more likely that the insured party is 0% or 100% liable if the hit and run indicator 318 indicates that the loss was not reported to be associated with a hit and run incident, relative to if the hit and run indicator 318 indicates that the loss was reported to be associated with a hit and run incident.

The liability dispute indicator 320 can be a value, input into the claim data 112 by a representative or other user, indicating whether or not at least one party associated with the insurance claim have indicated that there is a dispute between two or more of the parties. In some examples, the liability dispute indicator 320 can be set to “yes,” “no,” or “unknown.” For example, the liability dispute indicator 320 can be set to a “yes” value if a first party disputes a statement about the loss that has been provided by a second party. In some examples, it may be more likely that the insured party is 0% or 100% liable if the liability dispute indicator 320 is set to “no,” relative to if the liability dispute indicator 320 is set to “yes” or “unknown.”

The claimant violation indicator 322 can be a binary value, input into the claim data 112 by a representative or other user, indicating whether or not the claimant associated with the insurance claim received a traffic ticket, a citation, or other indication of a type of violation from a police officer or other authority in association with the loss. In some examples, it may be more likely that the insured party is 0% or 100% liable if the claimant violation indicator 322 indicates that the claimant did not receive a citation in association with the loss, relative to if the claimant violation indicator 322 indicates that the claimant did receive a citation in association with the loss.

Similar to the claimant violation indicator 322, the insured party violation indictor 324 can be a binary value, input into the claim data 112 by a representative or other user, indicating whether or not the insured party associated with the insurance claim received a traffic ticket, a citation, or other indication of a type of violation from a police officer or other authority in association with the loss. In some examples, it may be more likely that the insured party is 0% or 100% liable if the insured party violation indictor 324 indicates that the insured party did not receive a citation in association with the loss, relative to if the insured party violation indictor 324 indicates that the insured party did receive a citation in association with the loss.

The vehicle count 326 can be a numeric value, in the claim data 112, indicating a number of vehicles involved with the loss associated with the insurance claim. For example, if the insurance claim is associated with a loss involving three vehicles, the vehicle count 326 can be set to three. In some examples, a lower vehicle count 326 may be more likely to indicate that the insured party is 0% or 100% liable than a higher vehicle count 326.

The facts of loss statement length 328 can be a value indicating a number of words or characters in a facts of loss statement included in the claim data 112. The facts of loss statement can be text of a description, by at least one of the parties associated with the insurance claim, of facts and circumstances associated with the loss. For example, the facts of loss statement can describe, from the insured party's perspective, what happened before, during, and/or after an automobile accident. In some examples, the liability classifier 104 or an associated system element can calculate or derive the facts of loss statement length 328 by counting the number of words or characters in the facts of loss statement included in the claim data 112. In some examples, a shorter facts of loss statement length 328 may be more likely to indicate that the insured party is 0% or 100% liable than a longer facts of loss statement length 328.

The “V1 hit V2” indicator 330 can be an indicator of whether the facts of loss statement in the claim data 112 indicates that a first vehicle (“V1”) associated with the insured party hit a second vehicle (“V2”) during the incident associated with the loss, indicates that the second vehicle (“V2”) hit the first vehicle (“V1”) associated with the insured party during the incident associated with the loss, or indicates that some other type of situation occurred during the incident associated with the loss. For example, if the facts of loss statement indicates that V1 hit V2, the “V1 hit V2” indicator 330 can be set to “V1-V2.” If the facts of loss statement indicates that V2 hit V1, the “V1 hit V2” indicator 330 can be set to “V2-V1.” If the facts of loss statement indicates that some other situation occurred, the “V1 hit V2” indicator 330 can be set to “other.” In some examples, it may be more likely that the insured party is 0% or 100% liable if the “V1 hit V2” indicator 330 indicates that the facts of loss statement includes text saying either that V1 hit V2 or that V2 hit V1, relative to if the “V1 hit V2” indicator 330 indicates that the facts of loss statement includes text saying that another type of situation occurred.

The liability classifier 104 can have, or be associated with, a natural language processor 332 that is configured to evaluate the text of the facts of loss statement in the claim data 112. For example, the natural language processor 332 can be configured to identify words in the facts of loss statement, which may be used to determine the facts of loss statement length 328 described above. The natural language processor 332 can also use words identified in the facts of loss statement to identify any words or phrases indicative of a “V1 hit V2” situation or a “V2 hit V1” situation. In some examples, the natural language processor 332 can be configured to use linguistic part-of-speech tagging, a spacy part-of-speech model, and/or other types of natural language processing to identify words or phrases in the facts of loss statement that may be indicative of a “V1 hit V2” situation or a “V2 hit V1” situation. For instance, the natural language processor 332 may be configured to look for instances of “V1,” “V2,” “hit,” and/or corresponding synonyms, such that the natural language processor 332 may identify words or phrases such as “vehicle 1 hit vehicle 2,” “insured struck claimant,” “V2 rear ended V1,” or similar phrases that may be indicative of a “V1 hit V2” situation or a “V2 hit V1” situation. If the natural language processor 332 determines that the facts of loss statement describes a “V1 hit V2” situation or a “V2 hit V1” situation, the natural language processor 332, the liability classifier 104, or an associated system element can set the “V1 hit V2” indicator 330 associated with the claim data 112 to a corresponding value, such as “V1-V2” or “V2-V1.” If the natural language processor 332 determines some other type of situation, the natural language processor 332, the liability classifier 104, or an associated system element can set the “V1 hit V2” indicator 330 associated with the claim data 112 to a value such as “other.”

As discussed above, the machine learning model of the liability classifier 104 can be trained to identify which factors 302, and which values for the factors 302, are most predictive of the insured party is 0% or 100% liable. The training of the machine learning model can also be used to determine weights, or relative weights, associated with corresponding factors 302. For example, if the liability classifier 104 is based on a “CatBoost” model, the weights associated with the factors 302 can be feature importance values determined by “CatBoost” modeling. The “CatBoost” feature importance values can indicate an importance of each of the factors 302 on a scale of zero to one hundred, with the importance values associated with the factors 302 summing to one hundred. In the example of FIG. 3, weight or importance values associated with the factors 302 may indicate that some of the factors 302, such as the hit and run indicator 318 and the “V1 hit V2” indicator 330, are more important and/or should be weighted more heavily than other factors 302, such as the liability dispute indicator 320 or the reporting delay 316.

In some examples, the liability classifier 104 can periodically or occasionally be re-trained based on new and/or additional data. For example, as new claim data 112 for new insurance claims is received and processed by the claim processing groups 102, that data can be used as additional historical data to re-train the liability classifier 104. Over time as new claim data 112 is received and processed, new trends in the claim data 112 may lead to changes in the weights associated with the factors 302, the identification of new or different factors 302 that are predictive of insured parties being either 0% liable or 100% liable that should be added to the liability classifier 104 for consideration, the removal of one or more factors 302 from being considered by the liability classifier 104, and/or other changes to the liability classifier 104.

Overall, the liability classifier 104 can be configured to use information in the claim data 112 to identify or derive values associated with the various factors 302, and use corresponding weight values to generate the prediction 304 indicating the likelihood 306 that the insured party is either 0% liable or 100% liable. If the claim router 308 determines that the likelihood 306 of insured party being either 0% liable or 100% liable meets or exceeds the threshold 310, the claim routing decision 312 generated by the claim router 308 can indicate that the insurance claim should be assigned to the non-complex claim processing group 106. The claim data 112 can accordingly be routed to computing devices associated with the non-complex claim processing group 106. However, if the claim router 308 determines that the likelihood 306 of insured party being either 0% liable or 100% liable is less than the threshold 310, the claim routing decision 312 generated by the claim router 308 can indicate that claim data 112 is to be provided to the comparative negligence model 116 and/or other downstream claim routing elements 114. The comparative negligence model 116 and/or other downstream claim routing elements 114 can accordingly use the claim data 112 to determine whether to assign the insurance claim to the non-complex claim processing group 106 or to the complex claim processing group 108.

In some examples, the prediction 304 generated by the liability classifier 104 in association with an insurance claim may be provided to a claim processing group that is assigned to process the insurance claims. For example, if an insurance claim is assigned to the non-complex claim processing group 106 directly based on the likelihood 306 of the prediction 304 being at or above the threshold 310, the insurance claim or the corresponding claim data 112 can be flagged or tagged with an indicator that informs a claim handler in the non-complex claim processing group 106 of the predicted high likelihood that the insured party has either 0% liability or 100% liability. As another example, if the likelihood 306 of the prediction 304 was below the threshold 310, and the claim data 112 was processed by the comparative negligence model 116 and/or other downstream claim routing elements 114 before being routed to one of the claim processing groups 102, the claim data 112 may nevertheless be tagged with the predicted likelihood 306 of the insured party having either 0% or 100% liability. Accordingly, although the likelihood 306 may not have met the threshold 310, providing information about the likelihood 306 predicted by the liability classifier 104 may nevertheless provide a claim handler with insights about the insurance claim and/or the potential liability of the insured party.

In some examples, the liability classifier 104 can be used to generate the claim routing decision 312 during initial routing of an insurance claim to one of the claim processing groups 102, for example if the claim data 112 is an FNOL. However, in other examples, the liability classifier 104 may be used in other contexts.

As a first example, a specialized subrogation workflow associated with insured parties with 0% or 100% liability may be triggered within in the insurance company if the likelihood 306 of the prediction 304 generated by the liability classifier 104 meets or exceeds the threshold 310. For instance, if the claim data 112 indicates that a loss occurred in a particular state or locality in which local laws or regulations require police reports to be obtained for use during subrogation even if the insured party has 0% or 100% liability, the likelihood 306 of the prediction 304 meeting or exceeding the threshold 310 can trigger the initiation of a process to order a corresponding police report.

As another example, the liability classifier 104 can operate on claim data 112 for insurance claims that have already been assigned to a claim processing group. In these examples, the liability classifier 104 may make predictions, similar to prediction 304, that may indicate that an insurance claim should be transferred to a different claim processing group. For instance, if an insurance claim has already been assigned to the complex claim processing group 108, the liability classifier 104 may predict that there is a high likelihood that the insured party has 0% or 100% liability, and trigger an automatic transfer of the insurance claim from the complex claim processing group 108 to the non-complex claim processing group 106.

In some examples, different types of claim data 112 may be evaluated by the liability classifier 104 in such post-assignment contexts. For instance, if an insurance claim was assigned to the complex claim processing group 108 based on data in an FNOL, but a claim handler in the complex claim processing group 108 has begun investigating the loss and has gathered additional information, claim data 112 associated with the insurance claim may include additional data and/or more types of data relative to the FNOL. Accordingly, the liability classifier 104, or an alternate version of the liability classifier 104 that has been trained to evaluate a different or expanded set of factors 302, may use the FNOL data and the additional data to generate a new prediction of the likelihood of the insured party being 0% or 100% liable. If the likelihood of the new prediction meets or exceeds a threshold, the insurance claim may be automatically transferred to the non-complex claim processing group 106, the likelihood can be provided as an insight to a claim handler via a user interface, and/or the system can take any other action based on the likelihood of the new prediction.

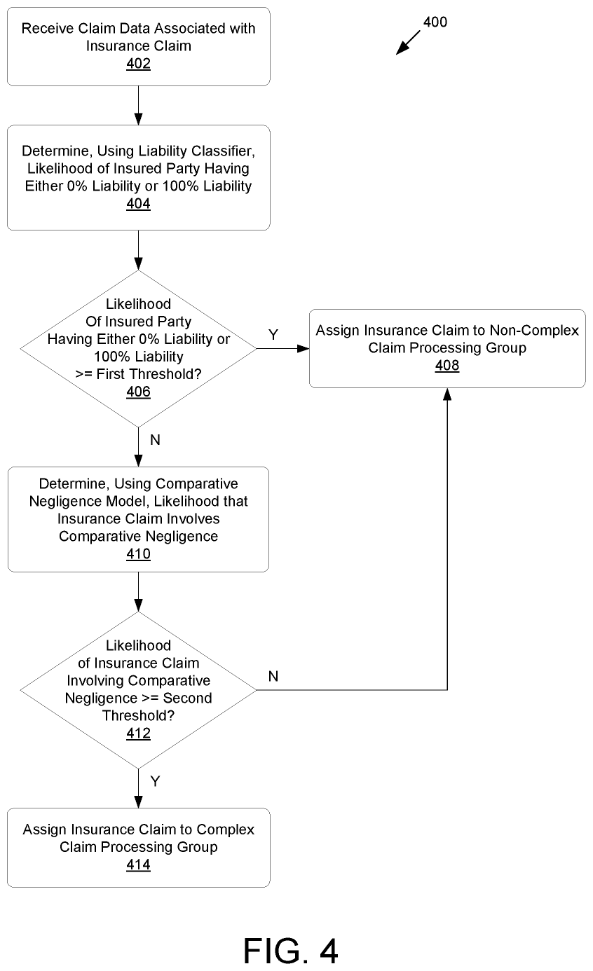

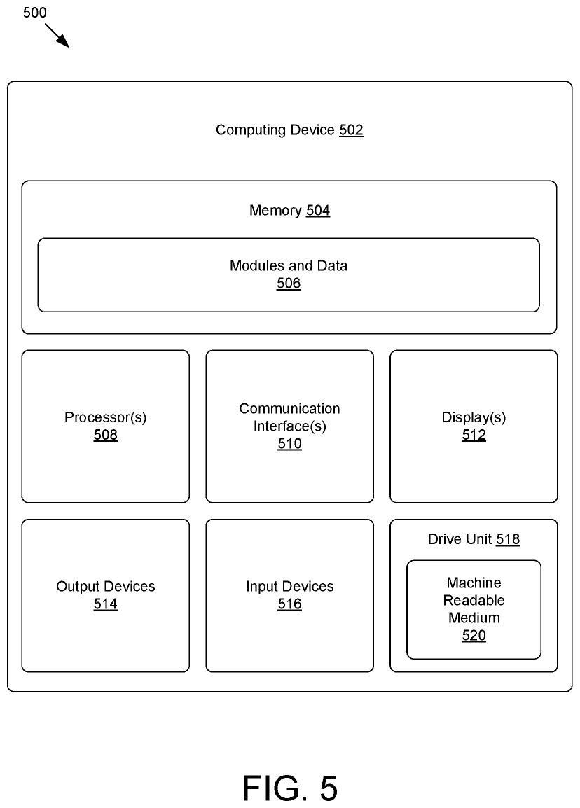

FIG. 4 shows a flowchart illustrating an example method 400 for determining whether to assign an insurance claim to either the non-complex claim processing group 106 or the complex claim processing group 108. The method 400 shown in FIG. 4 can be executed by one or more computing devices associated with a system that includes the liability classifier 104, such as the system 100 shown in FIG. 1 or the system 200 shown in FIG. 2. An example system architecture for such a computing device is described below with respect to FIG. 5.

At block 402, the system can receive claim data 112 associated with the insurance claim. For example, the claim data 112 can be received and/or generated by the claim intake system 110, and can be provided to the liability classifier 104 from the claim intake system 110, from a database or other data repository, or another system element. In some examples, one or more upstream elements 202, such as the rule-based models 204 shown in FIG. 2, may evaluate the claim data 112 in the system before the liability classifier 104 receives the claim data 112. For instance, the liability classifier 104 can receive the claim data 112 if one or more upstream elements 202 were unable to determine which claim processing group should be assigned to process the insurance claim.

At block 404, the system can determine, by evaluating the claim data 112 with the liability classifier 104, the likelihood 306 of the insured party having either 0% liability or 100% liability. For example, as discussed above with respect to FIG. 3, the liability classifier 104 can be a machine learning model that has been trained to generate a prediction, indicting the likelihood 306, based on a set of factors 302 associated with the claim data 112.

At block 406, the system can determine whether the likelihood 306, of the insured party having either 0% liability or 100% liability, is equal to or greater than a first threshold associated with the liability classifier 104. The first threshold can be set to 80%, 90%, 95%, or any other threshold value. In some examples, the first threshold can be the threshold 310 discussed above with respect to FIG. 3.

If the system determines that the likelihood 306, of the insured party having either 0% liability or 100% liability, is equal to or greater than the first threshold (Block 406—Yes), the system can cause the insurance claim associated with the claim data 112 to be assigned to the non-complex claim processing group 106 at block 408. For example, the system can route the claim data 112 to one or more computing devices and/or data repositories associated with the non-complex claim processing group 106, or otherwise associate the insurance claim with the non-complex claim processing group 106. The non-complex claim processing group 106 can accordingly take actions to further process the insurance claim.

However, if the system determines that the likelihood 306, of the insured party having either 0% liability or 100% liability, is less than the first threshold (Block 406—No), the system can route the claim data 112 to one or more downstream claim routing elements 114, such as the comparative negligence model 116. At block 410, system can determine, by evaluating the claim data 112 with the comparative negligence model 116, a likelihood that the insurance claim involves comparative negligence. For example, as discussed above, the comparative negligence model 116 can be a rule-based model, a machine learning model, or another model that is configured to determine, based on the claim data 112, a likelihood that comparative negligence issues are associated with the insurance claim.

At block 412, the system can determine whether the likelihood of the insurance claim involving comparative negligence, determined by the comparative negligence model 116, is equal to or greater than a second threshold associated with the comparative negligence model 116. The second threshold can be set to 80%, 90%, 95%, or any other threshold value. The second threshold associated with the comparative negligence model 116 can be set to a higher value, a lower value, or the same value as the first threshold value associated with the liability classifier 104. If the system determines that the likelihood of the insurance claim involving comparative negligence, determined by the comparative negligence model 116, is less than the second threshold (Block 412—No), the system can cause the insurance claim associated with the claim data 112 to be assigned to the non-complex claim processing group 106 at block 408, as described above.

However, if the system determines that the likelihood of the insurance claim involving comparative negligence, determined by the comparative negligence model 116, is equal to or greater than the second threshold (Block 412—Yes), the system can cause the insurance claim associated with the claim data 112 to be assigned to the complex claim processing group 108 at block 414. For example, the system can route the claim data 112 to one or more computing devices and/or data repositories associated with the complex claim processing group 108, or otherwise associate the insurance claim with the complex claim processing group 108. The complex claim processing group 108 can accordingly take actions to further process the insurance claim.

Although FIG. 4 shows an example in which the system routes claim data 112 to the comparative negligence model 116 if the likelihood 306, of the insured party having either 0% liability or 100% liability, is less than the first threshold (Block 406—No), in other examples, the system can route the claim data 112 to one or more other types of downstream claim routing elements 114 if the likelihood 306 is less than the first threshold (Block 406—No). For example, if the system does not include the comparative negligence model 116, but has other downstream claim routing elements 114 configured to determine which claim processing group should process the insurance claim, the system can route the claim data 112 to those other downstream claim routing elements 114 if the likelihood 306 is less than the first threshold (Block 406—No). As another example, if the likelihood 306 is less than the first threshold (Block 406—No), the system may route the claim data 112 to other downstream claim routing elements 114 before later routing the claim data 112 to be evaluated by the comparative negligence model 116 at block 410. Accordingly, in examples in which the system includes the comparative negligence model 116 and/or other types of downstream claim routing elements 114, a determination of the likelihood 306 being equal to or greater than the first threshold (Block 406—Yes), can cause claim data 112 to be assigned directly to the non-complex claim processing group 106 at block 408 such that the system can avoid processing the claim data 112 with the comparative negligence model 116 and/or other types of downstream claim routing elements 114.

FIG. 5 shows an example system architecture 500 for a computing device 502 associated with the systems described herein. The computing device 502 can be a server, computer, or other type of computing device that executes one or more portions of the systems, such as the claim intake system 110, the liability classifier 104, the comparative negligence model 116 and/or other downstream claim routing elements 114, the rule-based models 204 and/or other upstream systems 202, the claim router 308, and/or the natural language processor 332. In some examples, elements of the systems can be distributed among, and/or be executed by, multiple computing devices similar to the computing device shown in FIG. 5. For example, the liability classifier 104 may execute on a different computing device than the comparative negligence model 116 and/or other downstream claim routing elements 114.

The computing device 502 can include memory 504. In various examples, the memory 804 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 502 associated with the systems. Any such non-transitory computer-readable media may be part of the computing device 502.

The memory 504 can store modules and data 506. The modules and data 506 can be associated with one or more of the claim intake system 110, the liability classifier 104, the comparative negligence model 116 and/or other downstream claim routing elements 114, the rule-based models 204 and/or other upstream elements 202, the claim router 308, the natural language processor 332, and/or other elements described herein. Additionally, or alternately, the modules and data 506 can include any other modules and/or data that can be utilized by the systems to perform or enable performing any action taken by the systems. Such other modules and data can include a platform, operating system, and applications, and data utilized by the platform, operating system, and applications.

The computing device 502 can also have processor(s) 508, communication interfaces 510, a display 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with common types of volatile (RAM) and/or nonvolatile (ROM) memory.

The communication interfaces 510 can include transceivers, modems, interfaces, antennas, telephone connections, and/or other components that can transmit and/or receive data over networks, telephone lines, or other connections.

The display 512 can be a liquid crystal display, or any other type of display commonly used in computing devices. For example, a display 512 may be a touch-sensitive display screen, and can then also act as an input device or keypad, such as for providing a soft-key keyboard, navigation buttons, or any other type of input.

The output devices 514 can include any sort of output devices known in the art, such as a display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing device 502. The memory 504 and the processor(s) 508 also can constitute machine readable media 520.

Overall, the liability classifier 104 can be trained to generate predictions, based on claim data associated with insurance claims, indicating whether insured parties are likely to have either 0% liability or 100% liability for losses associated with the insurance claims. If the liability classifier 104 predicts, based on claim data 112, that an insured party has higher than a threshold likelihood of having either 0% liability or 100% liability, the associated insurance claim can be routed or assigned directly to the non-complex claim processing group 106. Otherwise, other downstream claim routing elements 114, such as the comparative negligence model 116, can further evaluate the claim data 112 to determine whether to assign the insurance claim to the non-complex claim processing group 106 or to the complex claim processing group 108.

Accordingly, by using the liability classifier 104 to identify insurance claims likely to have insured parties with either 0% or 100% liability, those insurance claims can be assigned to the non-complex claim processing group 106 more quickly. Additionally, the identification of such insurance claims and the assignment of the insurance claims to the non-complex claim processing group 106 can prevent corresponding claim data from being evaluated by the comparative negligence model 116 and/or other downstream claim routing elements 114, thereby reducing usage of memory, processor cycles, and other computing resources associated with the comparative negligence model 116 and/or the other downstream claim routing elements 114.

In some examples, the liability classifier 104 may also identify insurance claims likely to have insured parties with 0% or 100% liability, and assign those insurance claims to the non-complex claim processing group 106, even if the comparative negligence model 116 might otherwise have determined to assign some of the insurance claims to the complex claim processing group 108. In these examples, if the liability classifier 104 had not been present and some insurance claims were assigned to the complex claim processing group 108 based on determinations by the comparative negligence model 116 and/or other downstream claim routing elements 114, the complex claim processing group 108 may later have transferred those insurance claims to the non-complex claim processing group 106. However, by evaluating the insurance claims earlier by the upstream liability classifier 104, such insurance claims likely to have insured parties with 0% or 100% liability can be identified earlier and be directly assigned to the non-complex claim processing group 106, thereby reducing delays and inefficiencies associated with later transfers of insurance claims from the complex claim processing group 108 to the non-complex claim processing group 106. For example, network bandwidth usage associated with transferring or reassigning insurance claims between claim processing groups can be lowered, processing cycles, memory usage, and/or other computing resources associated with the complex claim processing group 108 can be saved, and/or insurance claims can be processed more quickly overall.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
obtaining, by one or more processors, claim data associated with an insurance claim;
generating, by the one or more processors, and using a liability classifier based on the claim data, a prediction of a likelihood of an insured party associated with the insurance claim having either 0% liability or 100% liability for a loss;
determining, by the one or more processors, that the likelihood meets or exceeds a threshold; and
generating, by the one or more processors, and based on the likelihood meeting or exceeding the threshold, a claim routing decision indicating that the insurance claim is to be assigned to a non-complex claim processing group configured to process less complex insurance claims than a complex claim processing group; and
causing, by the one or more processors, the claim data to be routed to one or more computing devices associated with the non-complex claim processing group.

2. The computer-implemented method of claim 1, wherein routing the claim data to the one or more computing devices associated with the non-complex claim processing group causes the claim data to bypass one or more downstream claim routing elements configured to further process the claim data to assign the insurance claim to either the non-complex claim processing group or the complex claim processing group.

3. The computer-implemented method of claim 2, wherein the one or more downstream claim routing elements comprise a comparative negligence model configured to determine, based on the claim data, a second likelihood of the insurance claim involving comparative negligence issues.

4. The computer-implemented method of claim 1, further comprising:
obtaining, by the one or more processors, second claim data associated with a second insurance claim;
generating, by the one or more processors, and using the liability classifier based on the second claim data, a second prediction of a second likelihood of a second insured party associated with the second insurance claims having either 0% liability or 100% liability for a second loss;
determining, by the one or more processors, that the second likelihood is below the threshold; and
routing, by the one or more processors, the second claim data to one or more downstream claim routing elements configured to assign the second insurance claim to either the non-complex claim processing group or the complex claim processing group.

5. The computer-implemented method of claim 1, wherein the claim data is a first notice of loss (FNOL) associated with the insurance claim.

6. The computer-implemented method of claim 1, wherein the liability classifier is a machine learning model that is trained, on a training set of data, to generate the prediction based on a set of factors.

7. The computer-implemented method of claim 6, wherein the set of factors are associated with corresponding weights determined based on training of the machine learning model on the training set of data.

8. The computer-implemented method of claim 6, wherein the set of factors includes at least one of:
a reported-by indicator in the claim data that identifies a party that reported the claim data,
a reporting delay associated with the claim data,
a hit and run indicator in the claim data,
a liability dispute indicator in the claim data,
a claimant violation indicator in the claim data,
an insured party violation indicator in the claim data,
a vehicle count indicated by the claim data,
a length of a fact of loss statement in the claim data, or
a vehicle-one-hit-vehicle-two indicator, derived from the fact of loss statement, indicating whether a first vehicle hit a second vehicle.

9. The computer-implemented method of claim 8, further comprising deriving, by the one or more processors, a value for the vehicle-one-hit-vehicle-two indicator by using a natural language processor to determine whether text of the fact of loss statement indicates whether the first vehicle hit the second vehicle.

10. A system, comprising:
a claim intake system configured to obtain claim data associated with an insurance claim;
a liability classifier configured to generate, based on the claim data, a prediction of a likelihood of an insured party associated with the insurance claim having either 0% liability or 100% liability for a loss; and
a claim router configured to compare the likelihood to a threshold and to route the claim data to:
a non-complex claim processing group based on the likelihood being equal to or above the threshold, or
a downstream claim routing element, configured to further process the claim data to determine whether to route the claim data to the non-complex claim processing group or to a complex claim processing group, based on the likelihood being below the threshold.

11. The system of claim 10, wherein routing the claim data to the non-complex claim processing group based on the likelihood being equal to or above the threshold causes the claim data to bypass being processed by the downstream claim routing element.

12. The system of claim 10, wherein the downstream claim routing element is a comparative negligence model configured to:
determine, based on the claim data, a second likelihood of the insurance claim involving comparative negligence issues;
compare the second likelihood to a second threshold; and
route the claim data to:
the complex claim processing group based on the second likelihood being equal to or above the second threshold, or
the non-complex claim processing group based on the second likelihood being below the second threshold.

13. The system of claim 10, wherein the claim data is a first notice of loss (FNOL) associated with the insurance claim.

14. The system of claim 10, wherein the liability classifier is a machine learning model that is trained, on a training set of data, to generate the prediction based on a set of factors.

15. The system of claim 14, wherein the set of factors includes at least one of:
a reported-by indicator in the claim data that identifies a party that reported the claim data,
a reporting delay associated with the claim data,
a hit and run indicator in the claim data,
a liability dispute indicator in the claim data,
a claimant violation indicator in the claim data,
an insured party violation indicator in the claim data,
a vehicle count indicated by the claim data,
a length of a fact of loss statement in the claim data, or
a vehicle-one-hit-vehicle-two indicator, derived from the fact of loss statement by a natural language processor associated with the liability classifier, indicating whether a first vehicle hit a second vehicle.

16. One or more non-transitory computer-readable media storing computer-executable instructions that, when executed by one or more processors, cause the one or more processors to perform operations comprising:
receiving claim data associated with an insurance claim;
generating, using a liability classifier based on the claim data, a prediction of a likelihood of an insured party associated with the insurance claim having either 0% liability or 100% liability for a loss;
determining that the likelihood meets or exceeds a threshold;
generating, based on the likelihood meeting or exceeding the threshold, a claim routing decision indicating that the insurance claim is to be assigned to a non-complex claim processing group configured to process less complex insurance claims than a complex claim processing group; and
causing the claim data to be routed to one or more computing devices associated with the non-complex claim processing group.

17. The one or more non-transitory computer-readable media of claim 16, wherein routing the claim data to the one or more computing devices associated with the non-complex claim processing group causes the claim data to bypass one or more downstream claim routing elements configured to further process the claim data to assign the insurance claim to either the non-complex claim processing group or the complex claim processing group.

18. The one or more non-transitory computer-readable media of claim 16, wherein the operations further comprise:
receiving second claim data associated with a second insurance claim;
generating, using the liability classifier based on the second claim data, a second prediction of a second likelihood of a second insured party associated with the second insurance claims having either 0% liability or 100% liability for a second loss;
determining that the second likelihood is below the threshold; and
routing the second claim data to a downstream comparative negligence model configured to assign the second insurance claim to either the non-complex claim processing group or the complex claim processing group, based on whether the downstream comparative negligence model determines that the insurance claim is likely to involve comparative negligence issues.

19. The one or more non-transitory computer-readable media of claim 16, wherein the claim data is a first notice of loss (FNOL) associated with the insurance claim.

20. The one or more non-transitory computer-readable media of claim 16, wherein the liability classifier is a machine learning model that is trained, on a training set of data, to generate the prediction based on a set of factors.
